(19) United States
(12) Patent Application Publication
(10) Pub. No.: US 2004/0038811 A1
(43) Pub. Date: Feb. 26, 2004

(54) Fe-doped silica catalyst

(76) Inventors: Adolfo Parmaliana, Terme Vigliatore (IT); Francesco Arena, S. Margherita (IT); Francesco Frusteri, Messina (IT)

Correspondence Address: Lynch Cox, Gilman & Mahan, Suite 2200, 400 West Market Street, Louisville, KY, 40202, US

(21) Appl. No.: 10/415,795

(22) PCT Filed: Nov. 2, 2001
(86) PCT No.: PCT/EP01/12728

(30) Foreign Application Priority Data
Nov. 3, 2000 (DE) 100544576

(51) Int. Cl. B01J 21/08

(52) U.S. Cl. 502/232; 502/240; 502/258

(57) ABSTRACT

The invention relates to a catalyst, in particular for the partial oxidation of methane or natural gas to formaldehyde and/or methanol in the tange of 550-800° C. with oxygen or air, comprising a silica carrier having

a BET-surface area of about 50 to 800 m²/g,

a pore volume of about 0.01 to 2 cm³/g,

a silanol group content of about 0.01 to 2/nm²,

a content of alkaline, alkaline earth and titania impurities of less than about 1.0 weight % and

a content of alumina of about 0 to 1 weight %

and an iron loading, expressed as Fe₂O₃, in the range of about 0.01 to 5 weight %, wherein the Fe-loading is about 0.01 to 10 Fe-atoms/nm² and the iron present as isolated Fe²⁺/³⁺-ions is higher than 10 weight %. The invention also relates to a method for preparing such catalyst and its use.

### DESCRIPTION

The invention relates to an Fe-doped silica catalyst which is particularly suitable for the partial oxidation of methane to formaldehyde (MPO), a process for the preparation of such catalyst and its use in MPO.

### BACKGROUND OF THE INVENTION

Formaldehyde is currently produced by two commercial processes: a) oxidation-dehydrogenation of CH₃OH with air on an Ag catalyst and b) oxidation of CH₃OH with air on a metal oxide catalyst (Formox process), about a third of the total demand of methanol being the feedstock for such process. The common technology for manufacturing formaldehyde consists of a multi-step process starting from methane via CO/H₂ to methanol and formaldehyde. This is a highly costly and energy-intensive sequence process for converting natural gas into a commodity chemical. Among the various catalytic routes proposed during the last decades for the conversion of natural gas to higher hydrocarbons, fuels or oxygenates, the direct partial oxidation to formaldehyde (MPO), being a potentially technological breakthrough, has attracted a great research interest. Many studies have addressed active and/or selective catalysts as well as the nature of the reaction pathway.

A great variety of transition metal oxide and multicomponent oxide catalysts, in bulk or supported form, have been claimed to be effective. A significant progress in this search has been made after 1986 focussing the studies on MoO₃ and V₂O₅ containing catalysts.

An overview of the great variety of transition metal oxide and multicomponent oxide catalysts may be found in O. V. Kryloff, Catal. Today, 18 (1993), page 209.

For example, EP 0 492 813 A2 discloses a process for oxidation of alkanes to alcohols wherein a C₁ to C₄ alkane is contacted with an oxygen containing gas at elevated temperature in the presence of a molybdenum oxide-containing catalyst.

U.S. Pat. No. 4,918,249 discloses and claims silicometallate molecular sieves and their use as catalysts in the oxidation of alkanes. The silicometallates claimed contain iron in the structural framework of the crystalline silicometallate.

British Patent No. 1 398 385 discloses improvements in or relating to the oxidation of gases which consist principally of hydrocarbons, wherein the oxydation catalyst generally comprises molybdenum or tungsten oxide, together with the oxide of a different metal of variable valency, the oxides being present either in combination, or free, or both.

U.S. Pat. No. 4,727,198 describes a method for making formaldehyde from methane and a molecular oxygen containing gas by using a silica supported catalyst having less than 350 ppm by weight of sodium and having a catalytically effective amount of V₂O₅.

U.S. Pat. No. 4,705,771 describes a similar method, wherein the silica supported catalyst has a catalytically effective amount of MoO₃ in the partial oxidation of methane or natural gas to formaldehyde in the range 550-800° C. with oxygen or air.

U.S. Pat. No. 3,996,294 describes a method for oxidizing methane to formaldehyde using silicon dioxide as catalyst, the silicon dioxide having a large internal surface area. Other metal oxides may be mixed with the silicon-dioxide.

However, the prior art catalysts suffer from several drawbacks with respect to their activity, selectivity and/or stability. Thus, many of the known MPO-catalysts have good space-time-yields (STY), but the corresponding values of formaldehyde yield per pass (mol %) so far reported are quite low. Due to the limited formaldehyde yields or low selectivity of the known catalysts for MPO, there is a considerable need for improved MPO catalysts.

It is therefore the object of the present invention to provide improved MPO catalysts having an excellent selectivity and activity allowing a good space-time-yield and product yield.

It is another object of the present invention to provide a method for preparation of such MPO catalyst.

It is a further object of the present invention to provide a method of use of such catalyst in the partial oxidation of hydrocarbons, in particular in the partial oxidation of methane to formaldehyde.

The objects of the invention are solved by a catalyst according to claim 1, a process according to claim 8 and a method of use according to claim 17. Preferred embodiments are indicated in the dependent claims.

The silica carrier of the present catalyst may be prepared by any convenient method, including precipitation, sol-gel preparation and pyrolysis. These methods are known to the skilled person and need not to be further discussed herein. A comparison of the performance in MPO of several silica samples may be found in A. Parmaliana, V. Sokolovskii, D. Miceli, F. Arena and N. Giordano, J. Catal. 148 (1994) 514. Thus, in previous studies, the activity of silica catalysts was correlated with both the concentration of strain siloxane bridges and densities of surface sites under steady state conditions. In general, the perfomance of the silica carriers in MPO is related to the preparation method resulting in the following reactivity scale: Precipitation>sol-gel>pyrolysis.

According to a preferred embodiment of the invention, the silica carrier may be prepared by the methods described in R. K. Iler “The Chemistry of Silica” (John Wiley, N.Y., 1979) and C. N. Satterfield “Heterogeneous Catalysis in Practice” (McGraw Hill, N.Y., 1991) which are explicitly incorporated by reference.

In the present invention, silica carriers having a relatively high BET-surface area of 50 to 800 m², preferably 200 to 600 m²/g, are preferred.

Also, it has been found that silica-carriers having a pore volume of 0,01 to 2 cm³/g, preferably 0.1 to 1.0 cm³/g, are preferred.

According to a further preferred embodiment of the invention, the silica carrier is amorphous. Thus, it has been unexpectedly found, that amorphous silica carriers are generally resulting in higher productivity values of the corresponding Fe-loaded catalyst than those with a crystalline silica carrier.

Also, it is preferred that the silanol group content is between 0.1 to 2/nm² of the surface of the silica carrier where a fraction of such groups gives rise to the formation of strained siloxane bridges under MPO reaction conditions.

It has further been found that the content of impurities of the silica carrier, especially of alkali metal, alkaline earth metal and titanium impurities, should be limited and will preferably be 0 to 0.1 weight %, calculated as oxides and based on the total weight of the silica carrier. Also, it is important to limit the alumina impurities to 0 to 1 weight % calculated as Al₂O₃ and based on the total weight of the silica carrier, as higher levels of impurities will lead to acidic Al-centers which impair the selectivity of the catalyst. Silica carriers fulfilling the above requirements are known to the skilled person.

The extensive studies performed within the present invention have shown that the iron loading of the catalyst should correspond to a Fe-content of 0.01 to 5 weight %, calculated as Fe₂O₃ and based on the total weight of the catalyst, preferably 0.03 to 1.5 weights. It was unexpectedly found that the highest HCHO productivity values are associated with optimum Fe-loading corresponding-to Fe₂O₃-contents of 0.1 to 1.0 weight %. The findings of the inventors lead to infer that for Fe₂O₃-loadings lower than 0.3-1.0 weight %, such value depending upon the surface area of the silica carrier, the Fe-addition results in a specific promoting effect while for higher Fe₂O₃-loadings (>0.3-1.0 weight %) the decrease in formaldehyde selectivity progressively outweights the enhancements in reaction rate. This results in a less selective oxidation catalyst increasingly leading to the formation of COₓ with a residual selective oxidation functionality.

The preferred Fe-loading corresponds to 0.01 to 10, preferably 0.02 to 2 Fe-atoms/nm² of the surface area of the silica carrier.

Although the invention is not bound to a theoretical mechanism, it is assumed that the isolated Fe²⁺/³⁺-ions (centers) are capable of transferring one oxygen atom at one time and are therefore particularly suitable for selective (partial) oxidation. In contrast, aggregated Fe₂O₃moieties may transfer more than one oxygen atom at the same time and therefore tend to favour complete oxidation of the hydrocarbons.

It has also been found that the above beneficial effect of isolated Fe²⁺/³⁺-ions is most pronounced when they are in tetrahedral coordination.

As pointed out above, the selectivity and HCHO productivity values of the-catalysts are mainly dependent on the presence of isolated Fe²⁺/³⁺-centers on the surface of the Fe/SiO₂-catalyst. In general, it has been found that the desired isolated Fe³⁺-ions may be present at Fe-loadings of between 0.01 to 5 weight %, in particular between 0.02 to 3 weight %. The above Fe-contents of 0.03 to 1.5 weight % are most preferred.

The presence of such isolated Fe-centers has been found to correlate well with certain signals in the Electron Paramagnetic Resonance (EPR) spectra. The most suitable catalysts have been found to show a ratio of the EPR-signal at g=3.9 to 4.4 to the EPR-signal at g=2.0 to 2.4 of equal or greater 3. Catalysts having a ratio of less than about 3 have been found to show lower selectivity.

It has also been found that an iron loading corresponding to the above Fe-content and showing the above-defined EPR signal ratio of equal or greater 3 may be used to promote the activity of various different silica (SiO₂) carrier materials. Thus, it was observed that even if the activity of the various unpromoted silica carriers is significant different, Fe-addition leads to comparative activities of the corresponding Fe-doped silica catalyst.

The physical parameters used for the characterization of the product of the invention were determined as follows:

1. BET-Surface Area:

The specific surface was determined by the BET-method (ASTM D 3663-84).

2. Pore Volume:

The pore volume was determined by nitrogen adsorption at −196° C. (method ASTM D 4645-88). In order to determine the pore volumes for different ranges of pore diameters, defined partial CCl₄ steam pressures were adjusted by mixing CCl₄ with paraffin.

3. Electron Paramagnetic Resonance (EPR):

EPR spectra were recorded at −196° C. and room temperature (25° C.) with a Bruker ER 200D spectrometer operating in the X-band and calibrated with a DPPH Standard (g=2,0036). A conventional high vacuum line capable of maintaining a dynamic vacuum below 10⁻⁴ Torr was employed for the different treatments. Spectra were recorded after outgassing of the samples at room temperature and 500° C.

In order to establish the EPR signal ratio, the relative amounts of the EPR signal at g=3.9 to 4.4 (signal A) and the EPR signal at g=2.0 to 2.4 (signal B) are obtained from the spectra of initial (freshly prepared) samples outgassed at room temperature. Signals A and B were normalised with respect to the corresponding maximum value recorded for all the samples. For signal A, values are evaluated from the heights of the signal in the spectra recorded at 77 K; the values for signal B are evaluated by integration of the spectra obtained at room temperature.

4. Fe-Content of SiO₂ and Fe/SiO₂ Catalysts

Fe content has been determined by Atomic Adsorption Spectroscopy (AAS) at 1=248.3 nm after dissolving the catalyst sample in HF aqueous solution.

### CATALYST PREPARATION AND EXAMPLES

According to another aspect of the present invention, there is provided a method for preparation of a Fe-doped silica (SiO₂) catalyst comprising the steps of:

Contacting a silica carrier with an iron salt by:

Incipient wetness of a solution of a FeII/FeIII salt;

Adsorption/impregnation with a solution of a FeII/FeIII salt;

Chemical vapour deposition (CVD), and

Co-precipitation of Fe^{II}/Fe^{III} ions and silica carrier.

Namely, the following method is a specific example of the above.

It is known that the prevailing covalent character of Fe—O bonds implies an easy tendency of Fe^{II}/Fe^{III} ions to form insoluble hydroxides which prevents an effective interaction of the silica carrier with positively charged species in a neutral-basic aqueous medium. On this account, conventional “adsorption” methods based on “ion exchange” or “electrostatic adsorption” cannot be applied for preparation of highly dispersed Fe/SiO₂ systems. Then, an original preparation method of Fe/SiO₂ catalysts, based on the “adsorption-precipitation” of Fe²⁺ ions on the silica surface from aqueous solutions under a nitrogen atmosphere and controlled pH conditions, has been disclosed. Such a method, favouring the interaction of negatively charged hydroxyl groups of the silica with Fe²⁺ ions at a pH ranging from 5.5 to 8.5, prevents the formation of hydroxides in the aqueous solution (i.e., [Fe²⁺]×[OH⁻]²<Kₐ=10⁻¹⁵) allowing an effective interaction between Fe²⁺ ions and negatively charged hydroxyl groups of the silica surface which results in a quasi-atomic dispersion of Fe²⁺ ions.

According to another aspect of the invention, the catalyst may be used for the oxidation, in particular, the partial oxidation of hydrocarbons. The preferred use is the partial oxidation of methane or natural gas to formaldehyde and/or methanol with oxygen or air in the range 550-800° C. However, the catalyst of the present invention may also be used in other reactions such as the oxidative dehydrogenation of alkanes to olefins and/or oxygenated products.

The invention is now illustrated by the following non-limiting examples.

### Example 1

A series of silica supported iron catalysts (samples Fx-SI) was prepared by the “incipient wetness” method, described in the following. An amount of Fe(NO₃)₃, corresponding to the desired final loading of Fe, was dissolved in 50 ml of distilled water at pH close to 2. The resulting solution was added step-wise to a powdered “precipitated” silica sample (Si 4-5P grade, Akzo Product, S.A._{BET}=400 m²×g⁻¹) and then dried at 100° C. to remove the excess of water. After the impregnation the catalysts were dried at 100° C. for 16 h and then calcined at 600° C. for 16 h. The list of samples, prepared according to such a method, along with their code, BET surface area, Fe₂O₃ content and Fe surface loading (S.L.) values are shown in Table 1.

TABLE 1
List of Fe doped SiO₂ Si 45-P catalysts

| | | Fe₂O₃ loading | S.A._{BET} | S.L. |
|---|---|---|---|---|
| SiO₂ Support | Code | (wt %) | (m² × g⁻¹) | (Feₐₜ × nm⁻²) |
| Si 4-5P | F1-SI | 0.086 | 400 | 0.0162 |
| Si 4-5P | F2-SI | 0.170 | 400 | 0.0320 |
| Si 4-5P | F3-SI | 0.270 | 400 | 0.0508 |
| Si 4-5P | F4-SI | 1.090 | 390 | 0.2105 |
| Si 4-5P | F5-SI | 3.250 | 370 | 0.6613 |

### Example 2

A series of silica supported iron catalysts (samples Fx-M5) was prepared by the “incipient wetness” method, described in the following. An amount of Fe(NO₃)₃, corresponding to the desired final loading of Fe, was dissolved in 50 ml of distilled water at pH close to 2. The resulting solution was added step-wise to a powdered “fumed” silica sample (M5 grade, Cabot Corporation, S.A._{BET}=200 m²×g⁻¹) and then dried at 100° C. to remove the excess of water. After the impregnation the catalysts were dried at 100° C. for 16 h and then calcined at 600° C. for 16 h. The list of samples, prepared according to such a method, along with their code, BET surface area, Fe₂O₃ content and Fe surface loading (S.L.) values are shown in Table 2.

TABLE 2
List of Fe doped SiO₂ M5 catalysts

| | | Fe₂O₃ loading | S.A._{BET} | S.L. |
|---|---|---|---|---|
| SiO₂ Support | Code | (wt %) | (m² × g⁻¹) | (Feₐₜ × nm⁻²) |
| M5 | F1-M5 | 0.023 | 200 | 0.0087 |
| M5 | F2-M5 | 0.087 | 200 | 0.0327 |
| M5 | F3-M5 | 0.200 | 203 | 0.0753 |
| M5 | F4-M5 | 0.830 | 200 | 0.3124 |

### Example 3

A silica supported iron catalyst (sample A) was prepared by the “adsorption-precipitation” method, described in the following. Six grams of a powdered “sol-gel” silica sample (CS 1020-E grade, PQ Corporation, S.A._{BET}=200 m²×g⁻¹) was contacted with a 0.3 litres volume of distilled water adjusting the resulting pH to a value of ca. 2.5. The suspension was vigorously stirred and kept under a nitrogen flow to remove any oxygen dissolved in the water and prevent any further air admission. Then, an amount of 10 g of FeSO₄×7H₂O was added to the stirred suspension at room temperature raising progressively (30 min) the pH to a value close to 6 by adding a concentrated ammonia solution. The suspension was kept at the final pH value under stirring and N₂ bubbling for 2 h, to attain the adsorption equilibrium of the Fe²⁺ species. Thereafter, the catalyst was recovered by filtering, washed with distilled water and then dried overnight at 100° C. and further calcined in air at 600° C. for 16 h. The iron content of the catalysts as determined by AAS, was found to be 0.27 wt % as Fe₂O₃.

### Example 4

A silica supported iron catalyst (sample B) was prepared by the “adsorption-precipitation” method, described in the following. Six grams of a powdered “precipitated” silica sample (Si 4-5P grade, Akzo product, S.A._{BET}=400 m²×g⁻¹) was contacted with a 0.3 litres volume of distilled water adjusting the resulting pH to a value of about 2.5. The suspension was vigorously stirred and kept under a nitrogen flow to remove any oxygen dissolved in the water and prevent any further air admission. Then, an amount of 10 g of FeSO₄×7H₂O was added to the stirred suspension at room temperature raising progressively (30 min) the pH to a value close to 6 by adding a concentrated ammonia solution. The suspension was kept at the final pH value under stirring and N₂ bubbling for 2 h, to attain the adsorption equilibrium of the Fe²⁺ species. Thereafter, the catalyst was recovered by filtering, washed with distilled water and then dried overnight at 100° C. and further calcined in air at 600° C. for 16 h. The iron content of the catalysts, as determined by AAS, was found to be 0.51 wt % as Fe₂O₃.

### Example 5

A silica supported iron catalysts (sample C) was prepared by the “adsorption-precipitation” method, described in the following. Ten grams of a powdered “precipitated” silica sample (Si 4-5P grade, Akzo Product, S.A._{BET}=400 m²×g⁻¹) was contacted with a 0.3 litres volume of distilled water with a resulting pH of about 4.5. The suspension was vigorously stirred and kept under a nitrogen flow to remove any oxygen dissolved in the water and prevent any further air admission. Then, an amount of 0.25 g FeSO₄×7H₂O was added to the stirred suspension at room temperature raising progressively (30 min) the pH to a value close to 8 by adding a concentrated ammonia solution. The suspension was kept at the final pH value under stirring and N₂ bubbling for 2 h, to attain a quantitative adsorption of the Fe²⁺ species. Thereafter, the catalyst was recovered by filtering, washed with distilled water and then dried overnight at 100° C. and further calcined in air at 600° C. for 16 h. Under such conditions, the efficiency of the preparation method, in terms of amount of Fe²⁺ adsorption, was better than 95% since the iron content of the catalyst, as determined by AAS, resulted equal to 0.77 wt % as Fe₂O₃.

### Example 6

Catalytic data in the MPO reaction were obtained using a specifically designed batch reactor. All the runs were carried out at 650° C. and 1.7 bar using 0.05 g of catalyst and a recycle flow rate of 1,000 STP cm³×min⁻¹. Further details on the experimental procedure and product analysis are reported in A. Parmaliana, V. Sokolovskii, D. Miceli, F. Arena and N. Giordano, J. Catal. 148 (1994) 514.

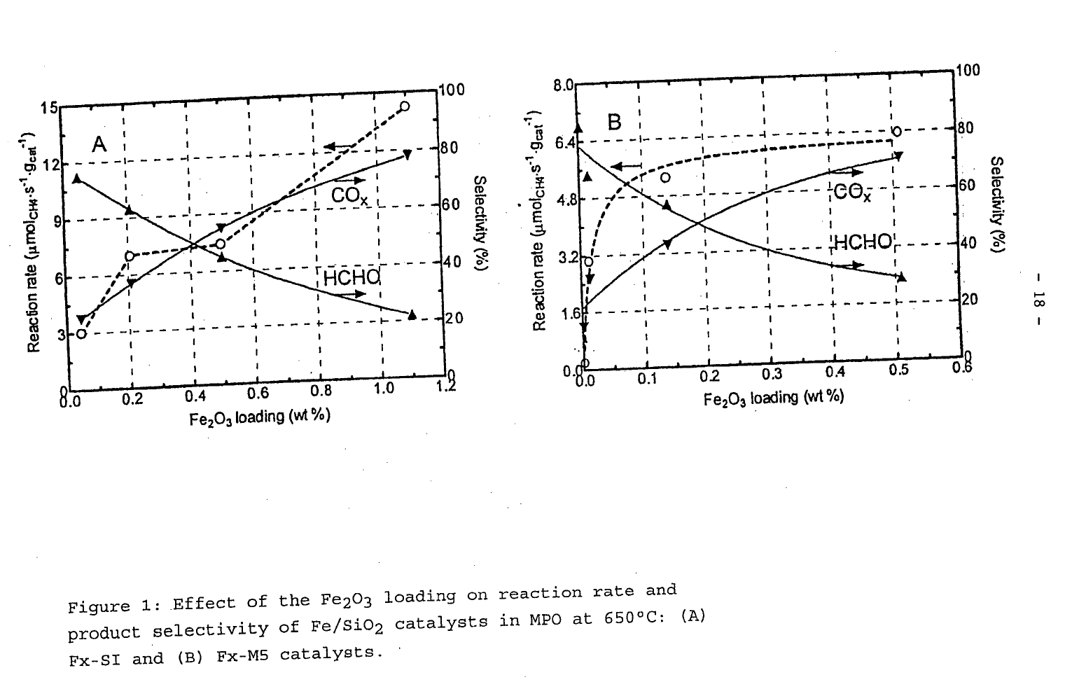

The catalytic behaviour of Fx-SI and Fx-M5 catalysts is outlined in FIG. 1 in terms of reaction rate and selectivity to HCHO and COₓ (CO+CO₂) vs. Fe₂O₃ loading. Addition of Fe³⁺ ions to the precipitated Si4-5P silica yields an enhancement in reaction rate and a concomitant decrease in HCHO selectivity, paralleled by a corresponding increases in COₓ (FIG. 1A). The extent of Fe content plays a critical role in controlling the performance of Fx-SI catalysts. Indeed, when the Fe₂O₃ loading rises from 0.045 (Si 4-5P) to 0.27 wt % (F3-SI catalyst) we observe a significant promoting effect on the reaction rate from 2.7 to 6.7 mmol_{CH4}×s⁻¹×g_{cat}⁻¹ and a modest lowering in HCHO selectivity from 78 to 62%. Notably, at higher loading, the F4-SI sample (Fe₂O₃, 1.09 wt %) exhibits a catalytic activity similar to that of the F3-SI system and a considerably lower HCHO selectivity (43%). The highly loaded F5-SI system (Fe₂O₃, 3.25 wt %) features the highest reaction rate value (14.2 mmol_{CH4}×s⁻¹×g_{cat}⁻¹) associated with the lowest HCHO selectivity (20%).

Doping of the fumed MS SiO₂ with different amount of Fe³⁺ ions implies a progressive promoting effect of the catalytic activity along with a gradual lowering in the selectivity to HCHO (FIG. 1B). Namely, the positive effect of Fe addition to the reactivity of the MS SiO₂ is analogous to that experienced for the Si 4-5P SiO₂ sample. In fact, we observe a significant promoting action up to a Fe₂O₃ loading of 0.2 wt % while for higher loading no further increase in the activity is observed. Moreover, in spite of the remarkable difference in activity of the bare M5 (0.2 mmol_{CH4}×s⁻¹×g_{cat}⁻¹) and Si 4-5P (3.1 mmol_{CH4}×s⁻¹×g_{cat}⁻¹) it is evident that the addition of similar amount of Fe³⁺ levels off the activity of the related Fe doped silica catalysts, as documented by the comparable activity of F3-SI (7.0 mmol_{CH4}×s⁻¹×g_{cat}⁻¹) and F3-M5 (5.3 mmol_{CH4}×s⁻¹×g_{cat}⁻¹), and F4-SI (7.4 mmol_{CH4}×s⁻¹×g_{cat}⁻¹) and F4-M5 (6.4 mmol_{CH4}×s⁻¹×g_{cat}⁻¹) catalyst samples.

On the whole, these findings lead to infer that for Fe₂O₃ loading lower than 0.3 wt % the Fe addition to the silica results in a specific promoting effect, while for higher Fe₂O₃ loadings (>0.3 wt %), where the decrease in HCHO selectivity outweighs the enhancement in reaction rate, we deal with non-selective oxidation catalysts leading to the formation of COₓ with a residual selective oxidation functionality. In other words, the catalytic behaviour of low doped Fe silica catalysts (Fe₂O₃<1.0 wt %) indicates that Fe content is a key factor tuning the activity of the SiO₂ surface in the MPO reaction irrespective of the preparation method and original functionality.

### Example 7

Electron Paramagnetic Resonance (EPR) spectra of undoped and Fe doped SiO₂ catalysts were recorded at −196° C. and r.t. (25° C.) with a Bruker ER 200D spectrometer operating in the X-band and calibrated with a DPPH standard (g=2.0036). A conventional high vacuum line (<10⁻⁴ torr) was employed for the different treatments. Spectra were recorded after outgassing of the samples at r.t. and 500° C.

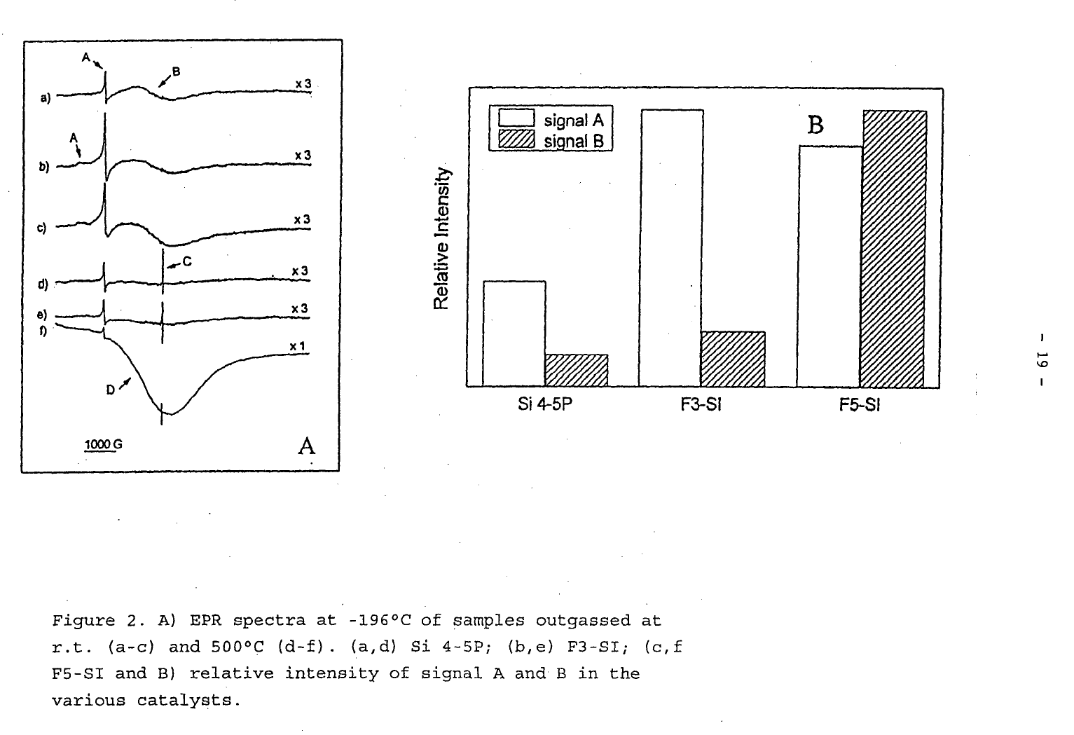

EPR spectra of bare SiO_{2 SI 4-5P}, F3-SI and F5-SI samples, recorded at −196° C. are shown in FIG. 2(A), while the relative intensity of signals A and B (see infra) is compared in FIG. 2(B). Two spectral features dominate the spectra; a narrow slightly anisotropic line at g_{eff}=4.32 (signal A) and a broad, almost symmetric signal, whose relative contribution to the spectra is apparently larger, centered at g_{eff}=2.24−2.18 (signal B). Independent experiments (not shown) have evidenced the sensitivity of these signals to an O₂ atmosphere, thus revealing the surface character of the corresponding centers. Apparent decrease of signals A and B, larger for the latter, along with a new weak and narrow isotropic signal at g=2.00 (signal C), arising probably from silica-related structural defects, are produced upon outgassing samples SI 4-5P and F3-SI at 500° C. (FIGS. 2d-e). For the sample F5-SI, in addition to signal C, a new very large and broad anisotropic signal showing a very large amplitude at low magnetic field, signal D, is produced upon this outgassing treatment (FIG. 2f). Signal A at g_{eff}=4.32 is attributed to isolated Fe³⁺ ions in a rhombic environment since it is difficult to ascertain the symmetry, octahedral or tetrahedral, accounting for such signal. The features observed at g_{eff}=9.0−6.0 are most likely due to the same isolated Fe³⁺ species, since the parallel evolution of these features and signal A; they would correspond to particular energy transitions resulting from the resolution of the spin Hamiltonian appropriate for Fe³⁺ high spin 3d⁵ systems like the present ones. It cannot be fully discarded, however, that these features belong to other different isolated Fe³⁺ species in an axial symmetry. The large anisotropy and width of signal D (and, in a lower extent, of signal B too) indicate that the species responsible for the signal are submitted to strong anisotropic fields due to magnetic interactions between the spins forming the corresponding oxidic phases. The higher linewidth of signal D with respect to signal B could be due to differences in the type of oxidic phase, which in the case of signal D might correspond to Fe₃O₄, formed by reduction of relatively larger Fe₂O₃ particles present in the sample F5-SI.

Thus, EPR data show the presence of different oxidized iron species, whose degree of aggregation grows with iron content.

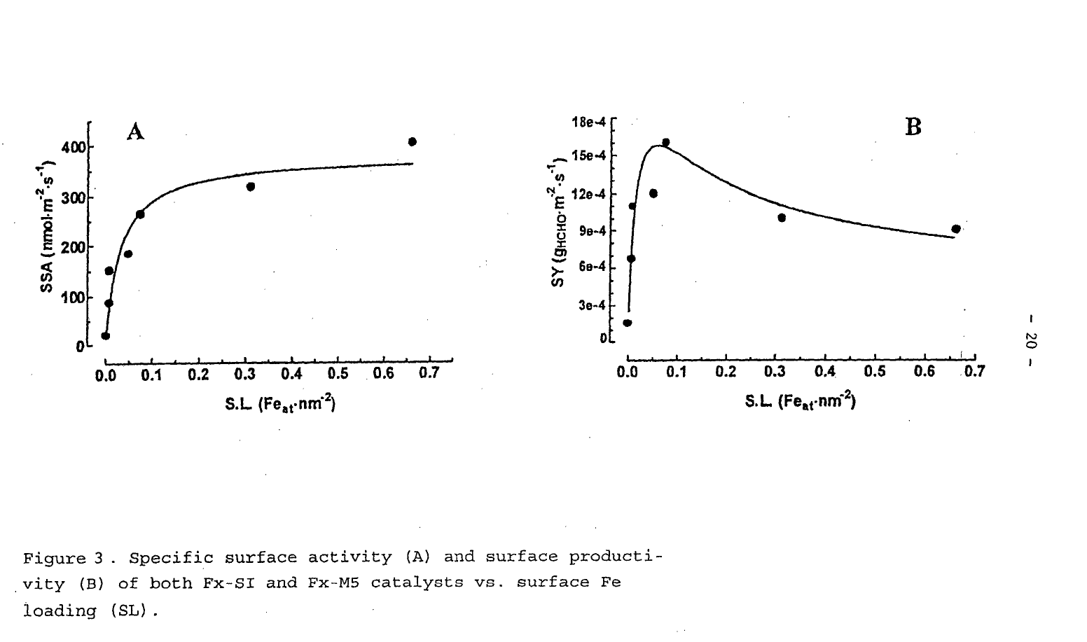

Accordingly, FIG. 2B, presenting the relative intensities of EPR signals A and B for the differently loaded Fx-SI samples, signals that low doped F3-SI sample is characterised by the highest concentration of isolated Fe³⁺ species (signal A), while the highest extent of aggregated species is present on the highly loaded F5-SI sample. Thus, considering the activity data shown in FIG. 1, a direct correlation exists between the amount of Fe³⁺ isolated centres and selective centres for partial oxidation of methane, while aggregated iron oxide phases would be related to the total combustion process. These findings are further explicated by the different trends of specific surface activity (SSA, nmol_{CH4}×m⁻²×s⁻¹) and surface productivity (SY, g_{HCHO}×m⁻²×h⁻¹) of all the studied catalysts vs. the surface Fe loading (Table 1), shown in FIG. 3. It is evident that the rising trend of SSA with the SL (FIG. 3A) points to a promoting role of any surface Fe species on the reactivity of the silica surface. However, the fact that the promoting role of Fe on SSA is much more sensitive at very low Fe₂O₃ loading (<0.2 wt %) besides to be in agreement with a more effective dispersion of the promoter on the silica at low SL (<0.1 Feₐₜ×nm⁻²), roughly confirms the 2^{nd}-order relationship between reaction rate and concentration of active sites outlined in our mechanistic studies /11,12/. By contrast, the specific functionality towards HCHO formation pertains to isolated Fe species, as proved by the maximum in SY value found for SL ranging between 0.05 and 0.1 Feₐₜ×nm⁻² (FIG. 3B).

From the trends depicted in FIG. 3, it arises that the surface Fe loading is a key-parameter allowing a rationalisation of the catalytic pattern of the Fe/SiO₂ system in MPO.

From the above it may be generally concluded that:

a) Addition of Fe³⁺ ions implies a significant promoting effect on the activity of any silica sample, levelling off the differences linked to their preparation method.

b) Isolated Fe³⁺ species, small clusters of Fe₂O₃ and large Fe₂O₃ particles are present on the surface of Fe/SiO₂ catalysts;

such species are characterised by different coordination, reducibility and catalytic functionality.

c) A peculiar volcano-shape relationship between surface Fe loading and surface productivity signals that the best performance of Fe/SiO₂ catalysts is related to the highest density of isolated Fe³⁺ sites on the silica support.

### Example 8

The catalyst samples F3-SI, F3-M5 and A, prepared according to the methods described through Examples 1 to 3, were comparatively tested in the MPO reaction at 650° C. by using the batch reactor and the operating procedure described in the Example 6.

The catalytic performance of the F3-SI, F3-M5 and A samples is presented in Table 3 in terms of hourly CH₄ conversion (%), product distribution (Sₓ, %); reaction rate (mmol×s⁻¹×g⁻¹) and Space Time Yield (STY, g_{HCHO}×kg_{cat}⁻¹×h⁻¹).

TABLE 3
Activity of Fe doped SiO₂ catalysts in the MPO
(T = 650° C.)

| | | S. | hrl. CH₄ | S_{HCHO} S_{CO} | | | | STY |
|---|---|---|---|---|---|---|---|---|
| | Fe₂O₃ loading | A._{BET} | conv. | S_{CO2} | | | Rate | (g_{HCHO} × |
| Catalyst | (wt %) | (m × g⁻¹) | (%) | (%) | | | (μmol/s/g) | kg_{cat}⁻¹ × h⁻¹) |
| F3-SI | 0.25 | 400 | 13.4 | 25 | 19 | 56 | 127 | 740 |
| F3-M5 | 0.20 | 200 | 5.6 | 24 | 19 | 57 | 53 | 330 |
| A | 0.24 | 200 | 20.3 | 20 | 35 | 45 | 195 | 950 |

1. Catalyst, in particular for the partial oxidation of methane or natural gas to formaldehyde and/or methanol in the range of 550-800° C. with oxygen or air, comprising a silica carrier having
a BET-surface area of about 50 to 800 m²/g,
a pore volume of about 0.01 to 2 cm³/g,
a silanol group content of about 0.1 to 2/nm²,
a content of alkaline, earth alkaline and titania impurities of less than about 0.1 weight %, as oxides and
a content of alumina of about 0 to 1 weight %;
and an iron loading, referred as Fe₂O₃, in the range of about 0.01 to 5 weight %, wherein the Fe-loading is about 0.01 to 10 Fe-atoms/nm² and the iron present as isolated Fe²⁺/³⁺-ions is higher than 10 weight % referred to the total Fe-content.

2. Catalyst according to claim 1, wherein the BET-surface of the silica carrier area is 200 to 600 m²/g.

3. Catalyst according to claim 1 or 2, wherein the pore volume of the silica carrier is about 0.1 to 1.0 cm³/g.

4. Catalyst according to any one of the preceding claims, wherein the silica carrier is amorphous.

5. Catalyst according to any one of the preceding claims, wherein the Fe-content, referred as Fe₂O₃, is from about 0.02 to 3 weight %, preferably from about 0.03 to 1.5 weight %.

6. Catalyst according to any one of the preceding claims, wherein about 0.01 to 2 Fe-atoms/nm² are present.

7. Catalyst according to any one of the preceding claims, wherein the Fe³⁺-centers have a tetrahedral coordination.

8. Process for the preparation of a catalyst, according to one of the claims 1 to 7, especially for the partial oxidation of methane to formaldehyde, comprising the steps of contacting a silica carrier having
a BET-surface area of about 50 to 800 m²/g,
a pore volume of about 0.01 to 2 cm³/g,
a silanol group content of about 0.1 to 2/nm²,
a content of alkaline, earth alkaline and titania impurities of less than about 0.1 weight %, as oxides and
a content of alumina of about 0 to 1 weight %;
with an iron salt prepared by one of the following methods:
incipient wetness of a solution of a Fe^{II/III}-salt, preferably Fe^{II}-salts;
adsorption/impregnation with a solution of a Fe^{II}-salt, by contacting the silica carrier under a nitrogen atmosphere with distilled water, adjusting the pH to a value of about 2.5 to 4.5, adding the Fe^{II/III}-salt and adjusting the pH in a range of 5.5 to 5.8, removing excess water and calcining the carrier;
chemical vapour deposition (CVD); or
co-precipitation of Fe and the silica carrier.

9. Process according to claim 8, wherein the silica carrier has a BET-surface area of about 200 to 600 m²/g.

10. Process according to claim 8 to 9, wherein the pore volume of the silica carrier is about 0.1 to 1.0 cm³/g.

11. Process according to any one of claims 8 to 10, wherein the silica carrier is amorphous.

12. Process according to any one of claims 8 to 11, wherein the silanol group content of the silica carrier is about 0.1 to 2/nm².

13. Process according to any one of claims 8 to 12, wherein the content of alkaline, alkaline earth and titania impurities of the silica carrier is less than about 1.0 weight %.

14. Process according to any one of claim 8 to 13, wherein the content of alumina is about 0 to 1 weight %.

15. Process according to any one of claims 8 to 14, wherein the Fe^{II/III}-precursor used is any one of inorganic or organic salts.

16. Use of the catalyst according to any one of claims 1 to 7, for the oxidation of hydrocarbons, preferably the partial oxidation of methane or natural gas to formaldehyde and/or methanol, preferably in the range of 550-800° C., with oxygen or air.
